(19) United States
(12) Patent Application Publication
(10) Pub. No.: US 2023/0222948 A1
(43) Pub. Date: Jul. 13, 2023

(54) Magnetic Hazmat Placard Holder

(71) Applicant: Timothy L. Ford, Mechanicsville, VA (US)

(72) Inventor: Timothy L. Ford, Mechanicsville, VA (US)

(21) Appl. No.: 18/153,287

(22) Filed: Jan. 11, 2023

Related U.S. Application Data
(60) Provisional application No. 63/298,917, filed on Jan. 12, 2022.

(51) Int. Cl. G09F 21/04

(52) U.S. Cl. CPC G09F 21/041

(57) ABSTRACT

A magnetic placard holder for securing placards to magnetic surfaces. The magnetic placard holder comprises a body, a front open panel, an insertion slot, a top clip, and a plurality of rear magnet sets. The front open panel attaches to the front surface of the body, delineating the insertion slot between the front open panel and the body. The top clip attaches to the body adjacent to the insertion slot, configured to selectively obstruct the insertion slot. The plurality of rear magnet sets attach to the rear surface of the body and are configured as a fastening mechanism to magnetic surfaces.

### FIELD OF THE INVENTION

The present invention relates to hazmat placards. More specifically, the present invention provides a hazmat placard holder that is attachable/detachable to any magnetic surface.

### BACKGROUND OF THE INVENTION

The US Department of Transportation (DOT) requires that all vehicles transporting dangerous goods must display the appropriate DOT hazard class placards. These durable, reliable DOT placards resist peeling, chipping and fading as they are printed with long-life UV inks that are designed to last. The purpose of placards is to attract instantaneous attention, they must be recognized from a distance and stand out from any background. This can prove troublesome with the current placards applied, as these are permanently fixed to their designated areas even though the vehicle which carries them may not be carrying hazardous materials.

An objective of the present invention is to provide a magnetic hazmat placard holder. The present invention provides a device that can attach to and detach from any metallic surface. The present invention provides hazmat placard holder that can easily be reused onto a plurality of metallic surfaces and metallic objects.

### SUMMARY OF THE INVENTION

The present invention is a magnetic placard holder to secure hazardous material placards to magnetic surfaces of vehicles in a manner that is well fastened and also reusable on different surfaces. The magnetic placard holder of the present invention comprises a body, a front open panel, an insertion slot, a top clip, and a plurality of rear magnet sets. The front open panel attaches to the front surface of the body, delineating the insertion slot between the front open panel and the body. The top clip attaches to the body adjacent to the insertion slot, configured to selectively obstruct the insertion slot. The plurality of rear magnet sets attach to the rear surface of the body and are configured as a fastening mechanism to magnetic surfaces. In use, the magnetic placard holder of the present invention is attached to a magnetic surface by the plurality of rear magnet sets and a placard is inserted into the insertion slot, secured by the top clip. The placard may be removed from the holder by opening the top clip and the holder may be fully removed from the magnetic surface by pulling the holder away from the magnetic surface.

### BRIEF DESCRIPTION OF THE DRAWINGS

FIG. 1 is a top front isometric view of the present invention in accordance with at least one embodiment.

FIG. 2 is a front elevation view of the present invention in accordance with at least one embodiment.

FIG. 3 is a rear elevation view of the present invention in accordance with at least one embodiment.

FIG. 4 is a right-side elevation view of the present invention in accordance with at least one embodiment.

FIG. 5 is a left-side elevation view of the present invention in accordance with at least one embodiment.

FIG. 6 is a bottom plan view of the present invention in accordance with at least one embodiment.

FIG. 7 is a top plan view of the present invention in accordance with at least one embodiment.

FIG. 8 is a top front isometric view of one of the plurality of rear magnet sets in accordance with at least one embodiment.

FIG. 9 is an illustration of the present invention with a placard inserted into the insertion slot.

### DETAIL DESCRIPTIONS OF THE INVENTION

All illustrations of the drawings are for the purpose of describing selected versions of the present invention and are not intended to limit the scope of the present invention.

The present invention provides a magnetic hazmat placard holder. The present invention provides a device that can attach to and detach from any magnetic surface. The present invention provides hazmat placard holder that can easily be reused onto a plurality of magnetic surfaces and magnetic objects. The present invention comprises a body 1, a front open panel 3, a top clip 4, and a plurality of rear magnet sets 2.

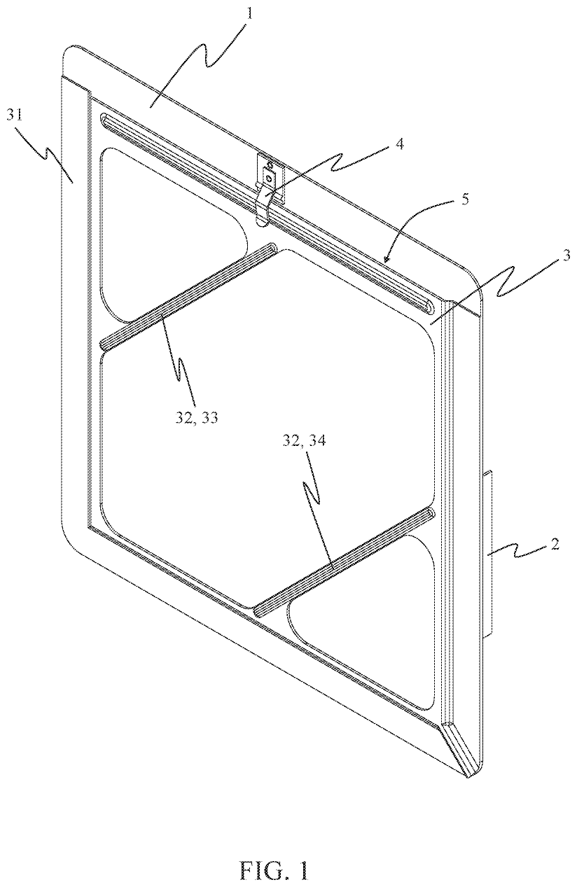

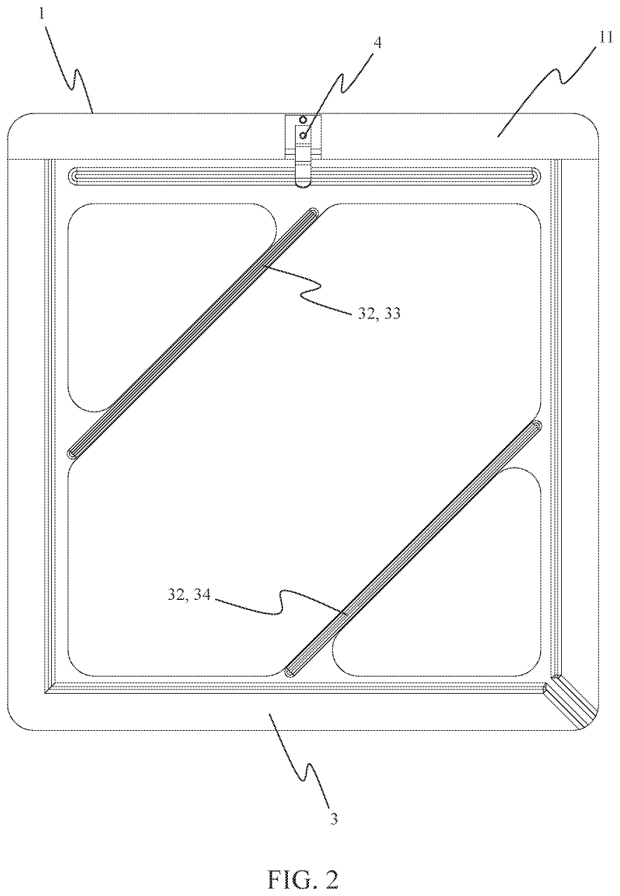

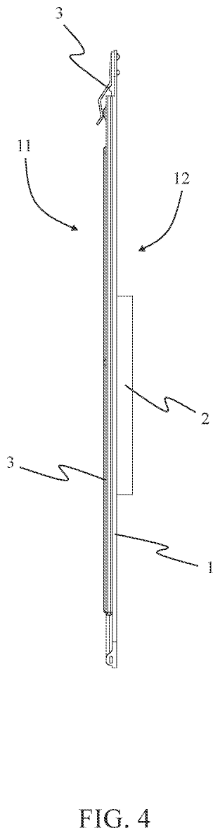

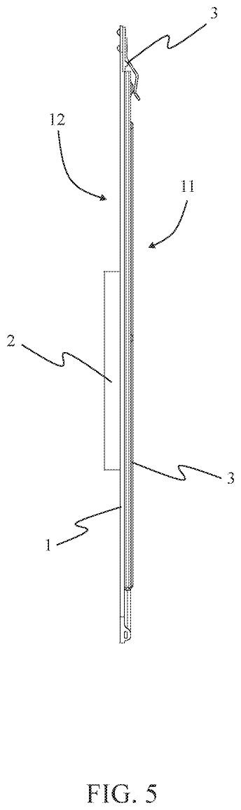

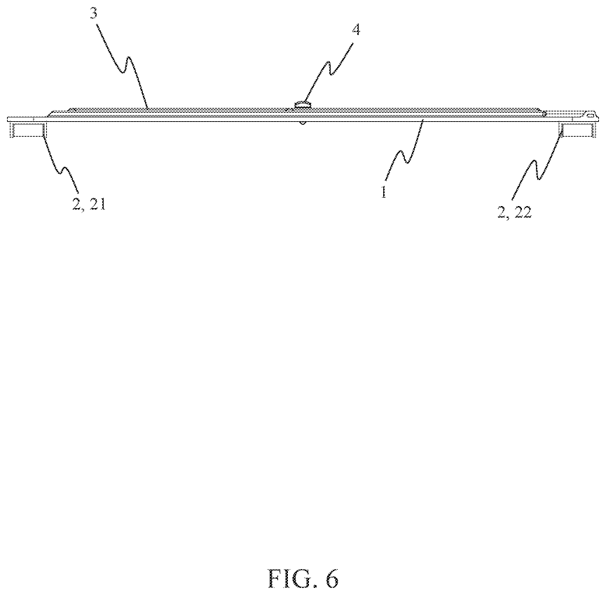

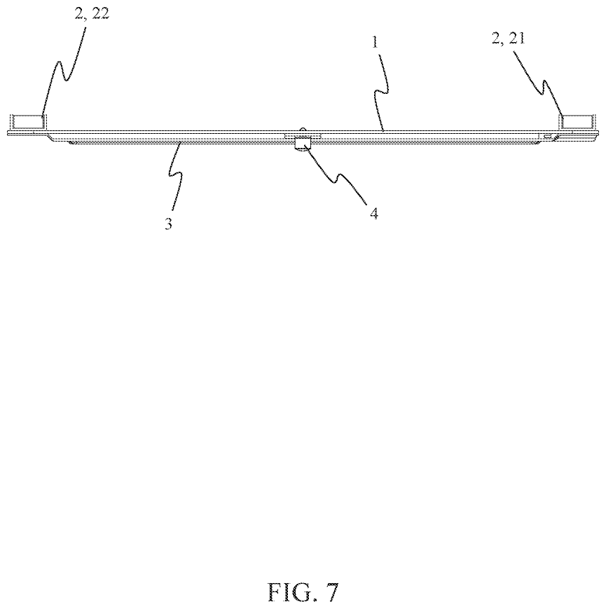

In reference to FIG. 1 through 9, the body 1 can be seen. The body 1 is the overall structure of the present invention. The body 1 is a flat rectangular panel. All of the other components of the present invention are attached to the body 1. The plurality of rear magnet sets 2 is attached on the rear surface 12 of the body 1. The front open panel 3 and the top clip 4 are attached on the front surface 11 of the body 1.

In reference to FIGS. 1, 2, and 9, the front open panel 3 is the component that delineates an insertion slot 5 for a placard between the front surface 11 of the body 1 and the front open panel 3. The insertion slot 5 is configured to accept and contain a hazardous material placard between the body 1 and the front open panel 3. The front open panel 3 is slightly smaller than the body 1. The front open panel 3 is a flat panel comprising a perimetrically positioned frame 31 allowing for the exposure of an inserted placard. The front open panel 3 also comprises plurality of diagonal linings 32 connected across the frame 31. The placard positioned in the placard holder is covered partially along the edges by the frame 31 and partially covered on its front by the plurality of diagonal linings 32, but is otherwise exposed, allowing the markings on the placard to be outwardly visible. In the preferred embodiment, the plurality of diagonal linings 32 comprises a first diagonal lining 33 and a second diagonal lining 34. The first diagonal lining 33 and a second diagonal lining 34 are preferably positioned at forty-five degrees relative to the frame 31. The first diagonal lining 33 is positioned to connect to the left side of the frame 31 to the top side of the frame 31. More specifically, the first diagonal lining 33 is located and positioned to the front side of the frame 31 starting from the center left side and connected to the center top side of the frame 31. The second diagonal lining 34 is positioned to connect to the bottom side of the frame 31 to the right side of the frame 31. More specifically, the second diagonal lining 34 is located and positioned to the front side of the frame 31 starting from the center bottom side and connected to the center right side of the frame 31. The first diagonal lining 33 and the second diagonal lining 34 are preferably parallel to one another. Further, the first diagonal lining 33 and the second diagonal lining 34 are preferably at a 45 degree angle relative to the frame 31. The plurality of diagonal linings 32 can be seen in FIGS. 1, 2, and 9.

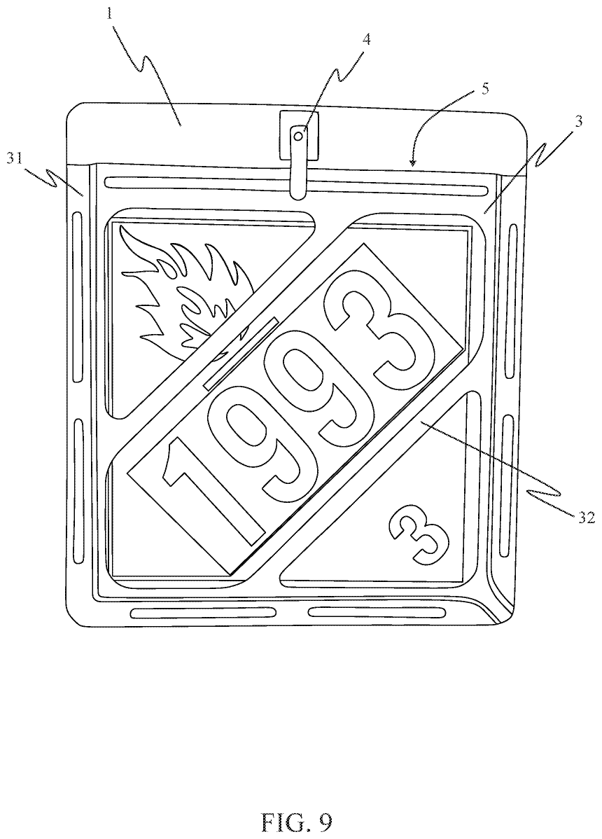

In reference to FIGS. 1, 2, 4, 5, and 9, the top clip 4 can be seen. The top clip 4 is a device for holding a placard in the insertion slot 5 between the front surface 11 of the body 1 and the front open panel 3. The top clip 4 is made of sturdy yet flexible material to allow for the removal and insertion of a placard. The top clip 4 is configured to selectively obstruct the insertion slot 5 by alternating between a closed state and an open state. In its closed state, the clip obstructs the insertion slot 5, preventing a placard from entering or exiting the insertion slot 5. The clip is able to rotate, flip, or otherwise open to its open state to allow for the removal and insertion of a placard between the body 1 and the front open panel 3. As can be seen in FIG. 9, the top clip 4 can be seen deployed for holding a placard between the body 1 and the front open panel 3. The top clip 4 is located on the front-top-center of the body 1. The top clip 4 is a protruding tab that is vertically pointing down when deployed to hold placard within the insertion slot 5 between the body 1 and the front open panel 3 as can be seen in FIGS. 1, 2 and 9.

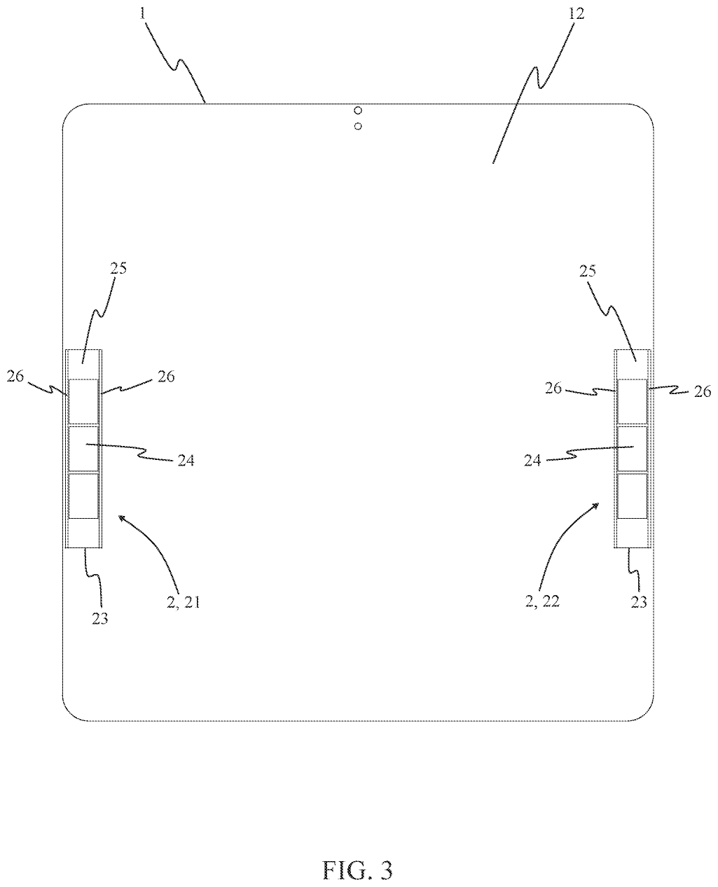

In reference to FIGS. 3, and 6-8, the plurality of rear magnet sets 2 be seen. The plurality of rear magnet sets 2 is used as a fastening mechanism. More specifically, the first rear magnet set 21 is used as a fastening mechanism for the present invention to attach to a metallic surface. The plurality of rear magnet sets allow for the present invention to be attached and removed to magnetic surfaces as needed. In the preferred embodiment, the plurality of rear magnet sets 2 of the present invention comprises a first rear magnet set 21, and a second rear magnet set 22. In reference to FIG. 10, the first rear magnet set 21, and the second rear magnet set 22 may be aligned vertically alongside the rear edge of the body 1. The first rear magnet set 21, and the second rear magnet set 22 are located on the rear surface 12 of the body 1. The first rear magnet set 21 and the second rear magnet set 22 are each vertically aligned with the edge of the body 1 as can be seen in FIGS. 3, 6, and 7. The first rear magnet set 21 and the second rear magnet set 22 are on opposite sides of the rear surface 12 of the body 1 as one another.

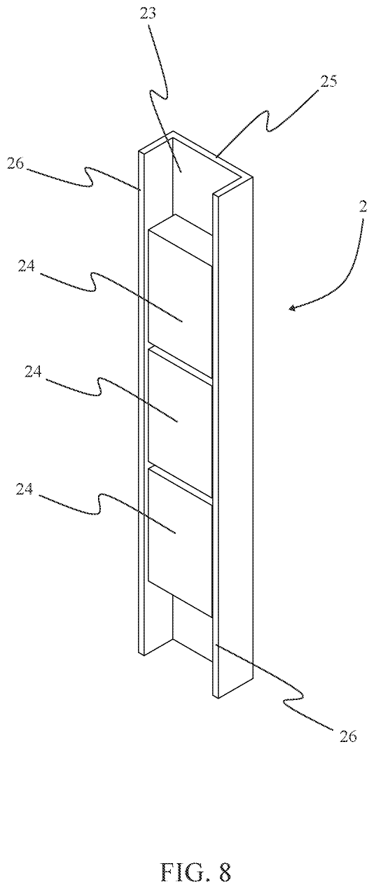

In reference to FIGS. 3, and 8, in the preferred embodiment, each of the plurality of rear magnet sets 2 comprise a magnet track 23 and at least one magnet 24. The at least one magnet 24 sits within the magnet track 23, positioning the at least one magnet 24 in a predetermined position on the rear surface 12 of the body 1. The magnet track 23 may be comprised of a base 25 and a set of sidewalls 26. The base 25 connects the plurality of rear magnet sets 2 to the rear surface 12 of the body 1 by screws, bolts, rivets, or other means. The set of sidewalls 26 extend from the base 25 away from the body 1, creating a channel. The two sidewalls of the set of sidewalls 26 are preferably straight and parallel to one another. The at least one magnet 24 sits against the base 25 in the channel between the set of sidewalls 26. The magnet track 23 not only aligns the at least one magnet 24 in a preferred position on the body 1, but also act as a protective casing for the at least one magnet 24, limiting its environmental exposure. Further, the magnet track 23 allows variation in the number, size, and strength of the magnets used without needing to swap out the entire placard holder.

To use the present invention, the user will find a metallic/magnetic surface to attach the present invention. The user will place the plurality of rear magnet sets 2 against the desired surface. Once attached, the user will position the present invention to their likings. After having the present invention positioned and attached, the user will insert a desired hazmat placard into the present invention. The user will maneuver the top clip 4 to the open position to allow the insertion of a placard into the insertion slot 5 between the body 1 and the front open panel 3. When the desired placard has been inserted, the user will maneuver the top clip 4 to the closed position downward against the front open panel 3 so that the placard is locked and secured to prevent the ejection of the placard. To remove the placard, the user will likewise maneuver the top clip 4 and open the insertion slot 5 between the body 1 and the front open panel 3. The user will remove the placard. In addition, the user may easily remove the present invention from the attached surface and place it onto another surface. The rear magnet set allow for easily and efficient usage onto different surfaces.

Although the invention has been explained in relation to its preferred embodiment, it is to be understood that many other possible modifications and variations can be made without departing from the spirit and scope of the invention.

What is claimed is:

1. A placard holder, comprising:
a body;
a front open panel;
an insertion slot;
a top clip;
a plurality of rear magnet sets;
the body having a front surface and a rear surface;
the front open panel attached to the front surface of the body;
the insertion slot being delineated between the body and the front open panel;
the top clip attached to the front surface of the body, adjacent to the insertion slot;
the plurality of rear magnet sets attached to the rear surface of the body; and
the plurality of rear magnet sets configured as a fastening mechanism to magnetic surfaces.

2. The placard holder of claim 1, further comprising:
the plurality of rear magnet sets comprising a first rear magnet set and a second rear magnet set;
the first rear magnet set and the second rear magnet set each being aligned with an edge of the body; and
the first rear magnet set oppositely positioned on the body from the second rear magnet set.

3. The placard holder of claim 1, further comprising:
each of the plurality of rear magnet sets comprising a magnet track and at least one magnet; and
the at least one magnet being positioned within the magnet track.

4. The placard holder of claim 3, further comprising:
the magnet track comprising a base and a set of sidewalls;
the base positioned between the rear surface of the body and the at least one magnet;
the set of sidewalls extending from the base away from the body; and
the at least one magnet positioned between the set of sidewalls.

5. The placard holder of claim 1, further comprising:
the front open panel comprising a frame and a plurality of diagonal linings;
the frame perimetrically positioned against the base; and
the plurality of diagonal linings connected across the frame.

6. The placard holder of claim 5, further comprising:
the plurality of diagonal linings comprising a first diagonal lining and a second diagonal lining; and
the first diagonal lining and the second diagonal lining positioned parallel to one another.

7. The placard holder of claim 1, wherein the insertion slot is configured to accept a hazardous material placard.

8. The placard holder of claim 1, wherein the top clip is configured to selectively obstruct the insertion slot.

9. A placard holder, comprising:
a body;
a front open panel;
a plurality of rear magnet sets;
the body having a front surface and a rear surface;
the front open panel attached to the front surface of the body;
the plurality of rear magnet sets attached to the rear surface of the body;
each of the plurality of rear magnet sets comprising a magnet track and at least one magnet;
the at least one magnet being positioned within the magnet track;
the magnet track comprising a base and a set of sidewalls;
the base positioned between the rear surface of the body and the at least one magnet;
the set of sidewalls extending from the base away from the body;
the at least one magnet positioned between the set of sidewalls; and
the plurality of rear magnet sets configured as a fastening mechanism to magnetic surfaces.

10. The placard holder of claim 9, further comprising:
the plurality of rear magnet sets comprising a first rear magnet set and a second rear magnet set;
the first rear magnet set and the second rear magnet set each being aligned with an edge of the body; and
the first rear magnet set oppositely positioned on the body from the second rear magnet set.

11. The placard holder of claim 9, further comprising:
an insertion slot;
the insertion slot being delineated between the body and the front open panel; and
the insertion slot being configured to accept a hazardous material placard.

12. The placard holder of claim 11, further comprising:
a top clip;
the top clip attached to the front surface of the body, adjacent to the insertion slot; and
the top clip being configured to selectively obstruct the insertion slot.

13. The placard holder of claim 9, further comprising:
the front open panel comprising a frame and a plurality of diagonal linings;
the frame perimetrically positioned against the base;
the plurality of diagonal linings connected across the frame;
the plurality of diagonal linings comprising a first diagonal lining and a second diagonal lining; and
the first diagonal lining and the second diagonal lining positioned parallel to one another.

14. A placard holder comprising:
a body;
a front open panel;
a plurality of rear magnet sets;
the body having a front surface and a rear surface;
the front open panel attached to the front surface of the body;
the plurality of rear magnet sets attached to the rear surface of the body;
the plurality of rear magnet sets configured as a fastening mechanism to magnetic surfaces;
the plurality of rear magnet sets comprising a first rear magnet set and a second rear magnet set;
the first rear magnet set and the second rear magnet set each being aligned with an edge of the body;
the first rear magnet set oppositely positioned on the body from the second rear magnet set;
the front open panel comprising a frame and a plurality of diagonal linings;
the frame perimetrically positioned against the base; and
the plurality of diagonal linings connected across the frame.

15. The placard holder of claim 14, further comprising:
each of the plurality of rear magnet sets comprising a magnet track and at least one magnet;
the at least one magnet being positioned within the magnet track;
the magnet track comprising a base and a set of sidewalls;
the base positioned between the rear surface of the body and the at least one magnet;
the set of sidewalls extending from the base away from the body; and
the at least one magnet positioned between the set of sidewalls.

16. The placard holder of claim 14, further comprising:
an insertion slot;
the insertion slot being delineated between the body and the front open panel; and
the insertion slot being configured to accept a hazardous material placard.

17. The placard holder of claim 16, further comprising:
a top clip;
the top clip attached to the front surface of the body, adjacent to the insertion slot; and
the top clip being configured to selectively obstruct the insertion slot.

18. The placard holder of claim 14, further comprising:
the plurality of diagonal linings comprising a first diagonal lining and a second diagonal lining; and
the first diagonal lining and the second diagonal lining positioned parallel to one another.
